(19) United States
(12) Patent Application Publication
(10) Pub. No.: US 2011/0233313 A1
(43) Pub. Date: Sep. 29, 2011

(54) FLUID INJECTION DEVICE

(75) Inventors: Andre Agneray, Boulogne Billancourt (FR); Nadim Malek, Versailles (FR); Laurent Levin, Paris (FR)

(73) Assignee: RENAULT S.A.S., Boulogne-Billancourt (FR)

(21) Appl. No.: 13/119,259

(22) PCT Filed: Jul. 29, 2009
(86) PCT No.: PCT/FR09/51525

§ 371 Date: Jun. 9, 2011

(30) Foreign Application Priority Data
Sep. 16, 2008 (FR) 0856218

(51) Int. Cl. B05B 5/025

(52) U.S. Cl. 239/690

(57) ABSTRACT

An injection device for injecting pressurized fluid includes a housing, an actuator, and an energizing unit. The housing includes at least one axial cavity filled with pressurized fluid. The actuator includes a stack with a first transverse face extended axially by a penetrating member and a second transverse face axially opposite the first. The stack includes at least one electroactive part including an electroactive material. The member includes a piston engaged in the cavity and forming a fluidic connection between the actuator and the housing. The energizing unit sets the electroactive part of the actuator in vibration with a set period τ. The penetrating member includes an axial length such that the propagation time T of the acoustic waves produced by the vibrations of the electroactive part of the actuator and traveling along this length satisfies the following equation: T=[2n+1]*[τ/4], where n is a positive integer coefficient.

The invention relates to a device for injecting a pressurized fluid, for example a fuel, particularly for an internal combustion engine.

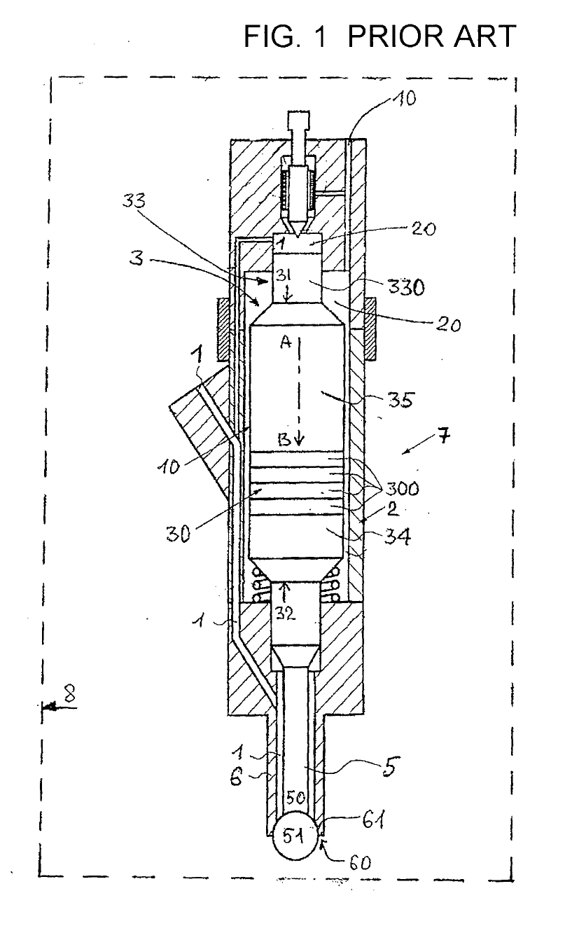

More specifically, the invention, according to a first of its aspects, relates to an injection device 7 for injecting pressurized fluid 1, known as an injector, like the one from the prior art partially illustrated in FIG. 1 and described, for example, in French patent application FR 2 888 889. This known injector 7 has a main axis of injection AS and comprises at least:
a housing 2 comprising at least one axial cavity 20 filled with pressurized fluid 1 and opening to the inside 20 of the housing 2,
an actuator 3 exhibiting a stack including at least one electroactive part 30 comprising an electroactive material 300 and endowed
   with a first transverse face 31 extended axially by a penetrating member 33, and
   with a second transverse face 32 axially opposite the first 31,
the actuator 3 being mounted so that it can move axially in the housing 2 and said member 33 comprising a piston 330 engaged in a substantially fluidtight manner in the cavity 20 and forming a fluidic connection between the actuator 3 and the housing 2,
energizing means designed to set the electroactive part 30 of the actuator 3 in vibration with a set period τ.

In the prior art, the fluidic connection is rendered imperfect by the fact that a seepage (an imperceptible flow) of liquid at the piston 330 needs to be provided in order to reduce the friction between the oscillating piston 330 and the stationary cavity 20.

That being the case, the object of the invention is to overcome this difficulty and provide a more effective fluidic connection. To this end, the injection device, in other respects in accordance with the generic definition given thereof in the above preamble, is essentially characterized in that said penetrating member has an axial length such that the propagation time T of the acoustic waves, known as the “acoustic time-of-flight”, produced by the vibrations of the electroactive part of the actuator and traveling along this length satisfies the following equation:

T=[2n+1]*[τ/4], (E1)

where n is a positive integer coefficient.

Arranging the injector in such a way should allow a tendency toward perfect sealing between piston and cavity. Thanks to a special acoustic structure and, notably, to the selective axial acoustic length of the penetrating member, the piston and, in particular, its free end directed toward the cavity and axially away from the first transverse face of the actuator, has a tendency to exhibit a vibration node, that is to say to remain practically immobile with respect to the cavity without thereby preventing a vibrational movement of the actuator within the housing. As a result, there is no longer any need to lubricate the piston which can then be machined to match the cavity, so as to prevent said seepage and afford a more effective fluidic connection.

According to a second of its aspects, the invention relates to an internal combustion engine using the fluid injection device according to the invention, that is to say such an engine in which this injection device is fitted.

Further features and advantages of the invention will become clearly apparent from the description thereof given hereinafter, by way of nonlimiting indication, with reference to the attached drawings in which:

FIG. 1 is a diagram of an injector according to the prior art, arranged in an engine and equipped with a needle of the so-called protruding tip type, associated with an actuator mounted axially in a housing,

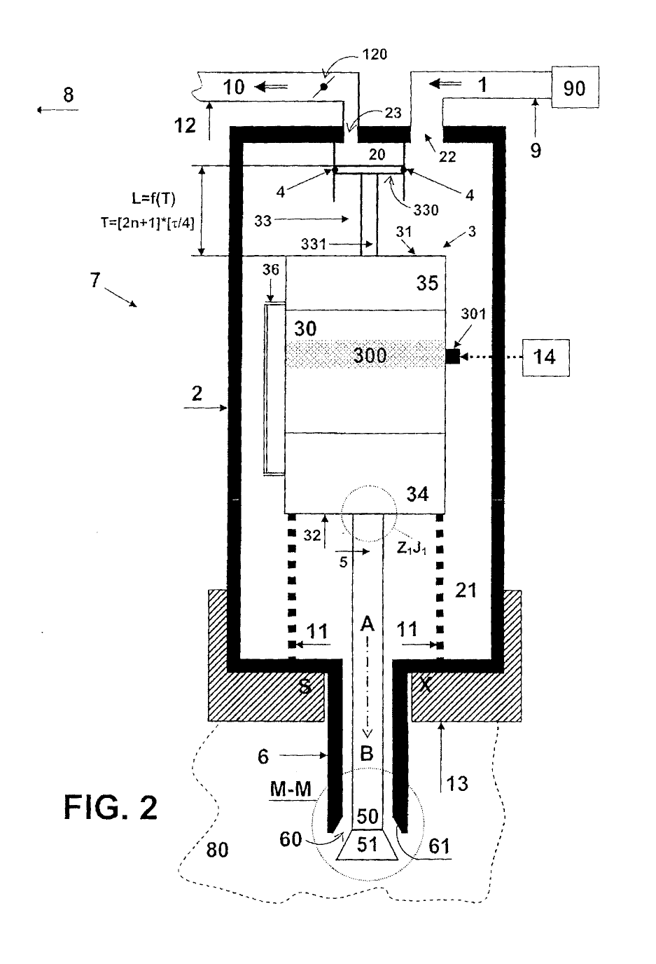

FIG. 2 is a diagram of an injector according to the invention, arranged in an engine and equipped with a needle of the so-called protruding tip type, associated with an actuator mounted axially in a housing,

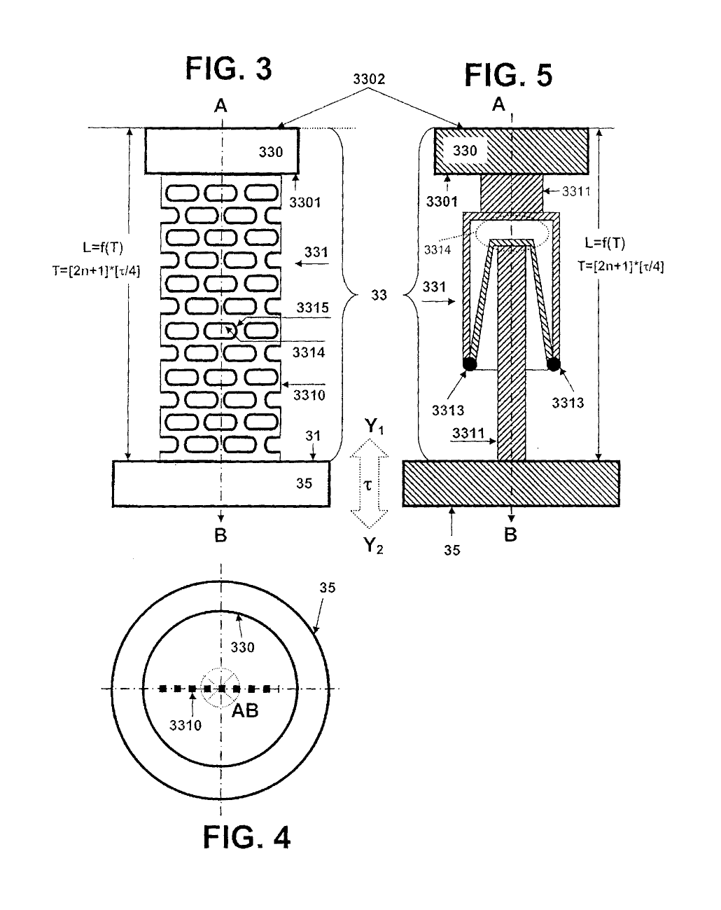

FIGS. 3 and 4 depict a penetrating member of an injector according to the invention comprising a piston and a perforated intermediate body with one-way cross section, in simplified schematic views, namely a side view (FIG. 3) and a top view (FIG. 4),

FIG. 5 schematically depicts a simplified longitudinal section through a penetrating member of an injector according to the invention comprising a piston and an intermediate body comprising at least one fold,

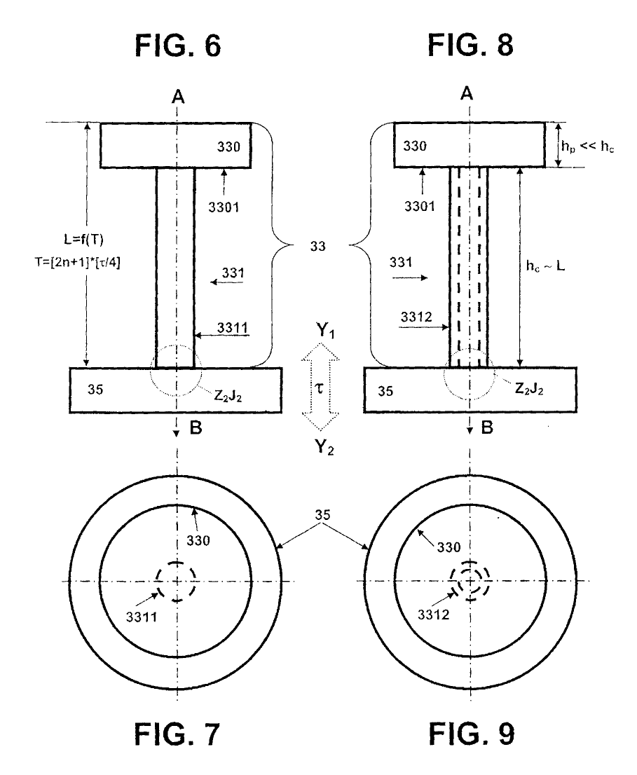

FIGS. 6 and 7 depict a penetrating member of an injector according to the invention comprising a piston and an intermediate body with a solid two-way cross section, in simplified schematic views, namely a side view (FIG. 6) and a top view (FIG. 7),

FIGS. 8 and 9 depict a penetrating member of an injector according to the invention comprising a piston and an intermediate body with a hollow two-way cross section, in simplified schematic views, namely a side view (FIG. 8) and a top view (FIG. 9),

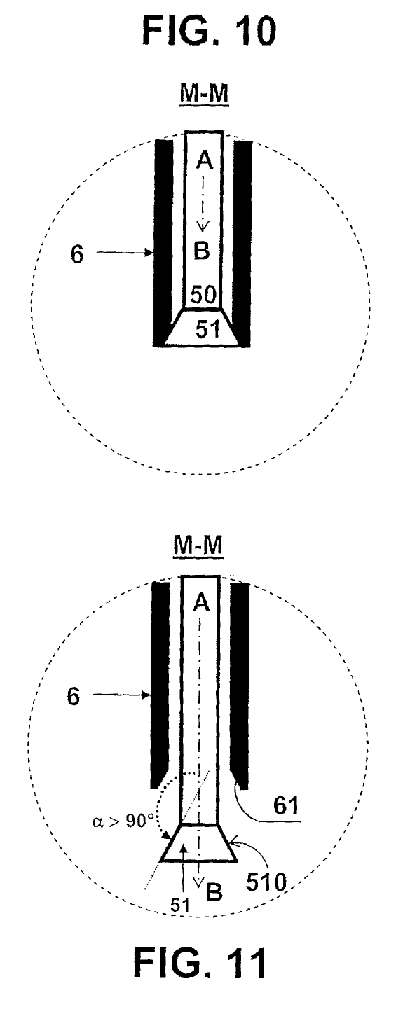

FIGS. 10 and 11 are diagrams illustrating operation of a valve formed of a nozzle and of a protruding-tip needle with the valve closed (FIG. 10) and the valve open (FIG. 11).

FIG. 1, which sets out the prior art, has already been discussed hereinabove.

As previously stated and as illustrated in FIGS. 2-11, the invention relates to an injection device 7, or injector, intended to inject a pressurized fluid 1 out of the injector 7. This may, for example, be a pressurized fuel 1 injected:
into a combustion chamber 80 of an internal combustion engine 8 (FIG. 2), or
into an air inlet duct (not depicted), or
into an exhaust duct and, notably, into an emissions control means housed in said exhaust duct, in order to facilitate an oxidation reaction therein, to oxidize the soot.

The injector 7 has a main axis of injection AB which, for preference, coincides with its axis of symmetry.

The injector 7 comprises at least one housing 2, preferably of cylindrical shape (for example exhibiting symmetry of revolution), comprising at least one axial cavity (bore) 20 filled with the pressurized fluid 1 and opening to the inside 21 of the housing 2. As FIG. 2 shows, the housing 1 may be connected to at least one pressurized circuit 9 of the engine 8 by at least one first pressurized opening 22. The pressurized circuit 9 comprises at least one device 90 for processing the pressurized fluid 1 comprising, for example, a pump, a tank, a filter, a valve. As in the abovementioned prior art, channels for conveying pressurized fluid 1 may be arranged in the housing 2 to connect the pressurized circuit 9 to the pressurized opening 22.

The injector 7 comprises at least one actuator 3 having a stack of cylindrical shape (for example exhibiting symmetry of revolution), including at least one electroactive part 30 comprising an electroactive material 300. The latter is intended to produce vibrations (illustrated using an arrow Y₁Y₂ in FIGS. 3, 5, 6, 8) with a predetermined frequency ν, for example an ultrasonic frequency which may extend between about 20 kHz and about 60 kHz, that is to say with the set period τ of vibrations comprised respectively between around 50 μs and around 16 μs. By way of example, for a steel, a vibration wavelength λ is around 10⁻¹ m at ν=50 kHz (τ=20 μs). The actuator 3 comprises at least energizing means 14 designed to set the electroactive part 30 in vibration (particularly axial vibration) with said set period τ.

The stack may coincide with the actuator 3 (FIG. 2) and is endowed with a first transverse face 31, extended axially by a penetrating member 33, and with a second transverse face 32 axially at the opposite end to the first 31. The linear dimensions of the penetrating member 33, for example its width measured perpendicular to the axis AB and/or its length measured along the axis AB, are smaller than those of the stack. Said penetrating member 33 may comprise a piston 330 engaged (for example axially) in a substantially fluidtight manner in the cavity 20 and forming a fluidic connection between the actuator 3 and the housing 2. Said fluidic connection works, as in a cylinder actuator, on a pressure difference acting across the piston 33 between the pressurized fluid 1 (from the pressurized regions of the injector 7 on the inside 21 of the housing 2 in FIG. 2) and this same fluid 10 reduced in pressure from depressurized regions of the injector 7 which have been depicted in FIG. 2 in the form of a depressurized circuit 12 connected to the cavity 20 via a depressurized opening 23 and at least one shut-off means 120 such as a valve.

The actuator 3 is mounted in the housing 2 such that it can move. Thus, the actuator 3 is designed to oscillate axially therein. It may also be designed to rotate on itself about the axis AB. By means of said fluidic connection, it is possible to bring the actuator 3 into a predetermined axial position with respect to the housing 1 and keep its position unchanged while the injector 7 operates under steady conditions, that is to say while it operates at a predetermined temperature outside the phases of starting and stopping the engine 8.

According to the invention, said penetrating member 33 has an axial length L, known as the acoustic length, such that the propagation time T for the acoustic waves produced by the vibrations of the electroactive part 30 of the actuator 3 and traveling along this length L satisfies the following equation:

T=[2n+1]*[τ/4], (E1)

where n is a positive integer coefficient (FIGS. 2-3, 5-6, 8).

It must be understood that the acoustic axial length L and the linear (nonacoustic) axial dimensions of the penetrating member 33 generally take the form of two distinct physical values. It should be noted that FIGS. 2-3, 5-6, 8 illustrate special cases in which these two values coincide.

For preference, said penetrating member 33 comprises at least one intermediate body 331 positioned axially between the piston 330 and the first transverse face 31. Further, the piston 330 protrudes radially beyond the intermediate body 331.

Thanks to this arrangement it is possible, on the one hand, to make the penetrating member 33 lighter in weight and, on the other hand, to create on the piston 330 a first bearing surface 3301 (FIGS. 3, 5-6, 8) directed toward the first transverse face 31 and designed to transmit to the intermediate body 331 (and, ultimately, to the actuator 3) a pressure force originating from the pressurized fluid 1. Thus it is possible to push the piston 330 (and, therefore, the actuator 3) axially using the pressurized fluid 1 acting on the first bearing surface 3301 (FIGS. 3, 5-6, 8) in a direction oriented toward the outside of the housing 2, in the opposite direction to the arrow AB in FIG. 2.

For preference, the acoustic axial length hₚ of the piston 330 is negligible by comparison with the length h_{c} of the intermediate body 331: hₚ<<h_{c} (FIG. 8). Likewise, the linear (nonacoustic) axial thickness of the piston 330 may be negligible by comparison with the linear (nonacoustic) axial dimensions of the intermediate body 331. These arrangements contribute toward making the penetrating member 33 more lightweight.

Said intermediate body 331 may be one of the following bodies: (a) a first body 3310 (such as a lamella 3310 illustrated in FIGS. 3-4) having, transversely to said axis AB, at least one one-way section; (b) a second body 3311 (such as a solid axial rod 3311 in the shape of a cylinder of revolution illustrated in FIGS. 5-7) having, transversely to said axis AB, at least one two-way solid section; (c) a third body 3312 (such as a sleeve tube 3312 illustrated in FIGS. 8-9) having, transversely to said axis AB, at least one two-way hollow section.

Thanks to these arrangements, it is possible to make the penetrating member 33 lighter still.

For preference, said intermediate body 331 is perforated (FIGS. 3, 5).

These arrangements also contribute toward reducing the weight of the penetrating member 33.

Said intermediate body 331 may comprise at least one fold 3313. FIG. 5 illustrates an alternative form of embodiment of the intermediate body 331 comprising two folds 3313 positioned symmetrically with respect to the axis AB. In addition, said intermediate body 331 may comprise at least one region of axial discontinuity 3314, as illustrated in FIG. 3 by means of an axial perforation 3315 and in FIG. 5 by means of the discontinuous solid axial rod 3311.

Thanks to these arrangements, it is possible to reduce only the axial size of said intermediate body 331 without altering its acoustic axial length L.

The injector 7 comprises at least one nozzle 6 having a length along the axis AB and comprising, along said axis AB, an injection orifice 60 and a seat 61. At the opposite end, the nozzle 6 is connected to the housing 2 (FIG. 2). The linear dimensions of the housing 2, for example its width measured perpendicularly to the axis AB and/or its length measured along the axis AB, may be greater than those of the nozzle 6. The density of the housing 2 may exceed that of the nozzle 6.

The injector 7 comprises at least one needle 5. It has, along said axis AB, a free end 50 that defines a valve in a region of contact with the seat 61. At the opposite end, the needle 5 is connected to the stack of the actuator 3 and, notably, to its second transverse face 32, by a first joining region Z₁J₁ (FIG. 2). The linear dimensions of the actuator 3, for example its width measured perpendicular to the axis AB and/or its length measured along the axis AB, may be greater than those of the needle 5. The density of the actuator 3 may be greater than that of the needle 5. The actuator is designed to set the needle 5 in vibration with said set period τ, creating, between its end 50 and the seat 61 of the nozzle 6, a relative movement capable of opening and closing the valve alternately, as illustrated in FIGS. 10-11. The actuator 3 thus acts as an active “master” controlling the needle 5 which then behaves as a controlled passive “slave”.

Thanks to these arrangements, a sheet formed of the pressurized fluid 1 escaping from the nozzle 6 when the valve opens is broken up and forms fine droplets (not depicted). In one application of the injector 7 in which it sprays fuel into the combustion chamber 80, the fine droplets encourage more uniform air/fuel mixing which reduces the emissions of the engine 8 and makes it more economical.

The end 50 of the needle 5 defining the valve is, for preference, extended longitudinally along the axis AB, away from the actuator 3, by a tip 51 that closes off the seat 61, so as to achieve better sealing of the injector 7 when the valve is closed (FIG. 10).

FIGS. 2, 10-11 illustrate the case of the needle 5 with the tip 51, known as the protruding tip, having a flared (and preferably frustoconical) divergent shape directed in the direction of the arrow AB in FIG. 2 from the housing 2 toward the outside of the nozzle 6 in the combustion chamber 80. For preference, at least one side wall 510 (which in the example in FIG. 11 is frustoconical) of the tip 51 makes, with the axis AB, an obtuse predetermined angle α (α>90°). The valve is defined at the site of the protruding tip 51, in a region of contact of the protruding tip 51 with the seat 61. The protruding tip 51 closes off the seat 61 on the outside of the nozzle 6 (directed away from the housing 1 in the direction of the arrow AB in FIG. 2). The seat 61 of the nozzle 6 may be of a respective flared (preferably frustoconical) shape diverging toward the outside of the nozzle 6. These arrangements contribute toward improving the sealing of the injector 7 when the valve is closed (FIG. 10).

As illustrated in FIG. 2, the stack comprises at least one part 34, known as the amplifier 34, axially connected to the needle 5 at the site of the second transverse face 32, the electroactive part 30 and the needle 5 being arranged axially on each side of the amplifier 34. The latter is designed to transmit the vibrations of the electroactive material 300 to the needle 5, amplifying them in such a way that the movements of the needle 5 at the valve are greater than the sum of the deformations of the electroactive material 300. The amplifier 34 may have a substantially cylindrical shape, for example exhibiting symmetry of revolution (FIG. 2). Alternatively, the amplifier 34 may have a different shape (not depicted), for example a frustoconical shape, narrowing in the direction of the axis AB directed from the electroactive part 30 toward the needle 5.

The stack further comprises at least one other part 35, known as the rear mass 35, the amplifier 34 and the rear mass 35 being positioned axially one on each side of the electroactive part 30. The rear mass 35 has a wall axially at the opposite end to the electroactive part 30, said wall coinciding with the first transverse face 31 of the stack.

The rear mass 35 contributes toward a more uniform (transversely to the axis AB) distribution of the axial stresses on the electroactive material 300 as a result of mechanical loadings. Thus it is possible to reduce the number of cracks and/or breakages of the electroactive material 300 during, for example, assembly and/or operation of the injector 7.

For preference, the electroactive material 300 is piezoelectric and may, for example, come in the form of one or more ceramic piezoelectric washers stacked axially on top of one another to form the electroactive part 30 of the stack. The selective deformations of the electroactive material 300, for example the periodic deformations with the set period τ, generating the acoustic waves in the injector ultimately result in the relative longitudinal movements of the tip 51 of the needle 5 in relation to the seat 61 of the nozzle 6, or vice versa, capable alternately of opening and closing the valve, as mentioned hereinabove in conjunction with FIGS. 2 and 10-11. These selective deformations are controlled by corresponding energizing means 14 designed to set the electroactive part 30 of the stack in vibration with the set period τ, for example using an electric field created by a potential difference applied, via wires (not depicted), to electrodes 301 attached to the piezoelectric electroactive material 300. Alternatively, the electroactive material 300 may be magnetostrictive. The selective deformations thereof are controlled by corresponding energizing means, not depicted, for example using magnetic induction resulting from a selective magnetic field obtained using, for example, an energizer, not depicted, and, in particular, a coil attached, for example, to the stack or another coil surrounding the stack.

The amplifier 34, the electroactive part 30 and the rear mass 35 are:
on the one hand, clamped together by a preload means 36 designed at least partially to preload said stack, and
on the other hand, designed to have passing through them acoustic waves initiated by the vibrations of the electroactive part 30.

Thanks to these arrangements, the actuator 3 (with, on the one hand, the penetrating member 33 and, on the other hand, the needle 5) forms a medium for the propagation of acoustic waves which have at least a linear acoustic impedance I which is dependent on a surface area Σ of a cross section of the medium perpendicular to the axis AB, on a density ρ of the medium and on a speed of sound through the medium c: I=f_{I}(Σ, ρ, c). It is thus possible to obtain injector 7 valve opening that is somewhat insensitive to the pressure in the combustion chamber 80 by movement-control of the end 50 of the needle 5. Likewise, given said selective acoustic length L of the penetrating member 33, expressed using equation E1 above, it is possible to keep dynamically immobile or axially fixed, in the manner of a displacement node, a second bearing surface 3302 (and, more generally, a surface of the piston 330) of the penetrating member 33 directed toward the cavity 20 and designed, once in contact with the fluid 1, to transmit an axial force which is specific to said fluidic connection in order to regulate said predetermined axial position of the actuator 3 in the injector 7. The second bearing surface 3302 is kept dynamically immobile by keeping its longitudinal speed along the axis AB equal to zero, making good use of the periodicity of the phenomenon of the propagation of the acoustic waves leaving the rear mass 35 through the penetrating member 33.

The intermediate body 331 takes the form of a body of which the radial dimensions perpendicular to the axis AR are small by comparison with its linear (nonacoustic) axial dimensions. As mentioned hereinabove, the linear (nonacoustic) axial dimensions of the piston 330 (just like its axial thickness) can be negligible by comparison with those of the intermediate body 331. As a result, a simplified acoustic model of the penetrating member 33 can be represented by a rod (a solid rod (FIG. 6) or a hollow rod (FIG. 8), for example, pierced longitudinally) set into the rear mass 35 in a second joining zone Z₂J₂. The propagation of the acoustic waves combines the propagation of a tension (force) jump ΔF₀ and of a speed jump Δv using an equation: ΔF₀=Σ*Δτ=Σ*z*Δv, where Σ is a surface area of a cross section of the rod perpendicular to its main axis AB, for example its axis of symmetry, Δτ=z*Δv is a stress jump, z is an acoustic impedance defined by an equation: z=ρ*c where ρ is a density of the rod and c is the speed of sound through the rod. It must be understood that the tension F₀ is positive for a compression and that the speed v is positive in the direction of propagation of the acoustic waves. The product I=Σ*z=Σ*ρ*c representative of the acoustic properties of the rod—solid or hollow—is known as the “acoustic linear impedance” or “linear impedance”.

At least one first break in linear impedance I occurs in the second joining zone Z₂J₂. The term “break” must be understood to mean “a variation in linear impedance I exceeding a predetermined threshold representative of a difference between the linear impedance upstream and that downstream, in relation to the direction of propagation of the acoustic waves, of a linear impedance break region situated in a medium through which the acoustic waves propagate over a distance which is short by comparison with the wavelength, preferably of less than one-eighth of the wavelength λ/8”. A second break in linear impedance I occurs at the end of the penetrating member 33 (or, when the acoustic axial length hₚ of the piston 330 is negligible, at the end of the intermediate body 331), axially at the opposite end from the rear mass 35. As for the acoustic axial length L=f(T), expressed in acoustic time-of-flight T, this is measured between the first and second breaks in linear impedance I.

It should be understood that equation E1 above is to be considered as satisfied, within a certain tolerance designed to account for manufacturing constraints, for example, a tolerance of the order of ±10% of the set period τ, that is to say of the order of ±40% of said quarter of the set period τ/4. Taking this tolerance into consideration, equation E1 above can be rewritten as follows:

T=[2n+1]*[τ/4]±0.4*[τ/4], (E2)

In practice, the acoustic axial length L=f(T) expressed in acoustic time-of-flight T, measured on corresponding components produced on an industrial scale, may exhibit slight variations from the reference values calculated using equation E1 above. These slight variations may be due to an added mass effect. These added masses may, for example, correspond to a guide boss (not depicted) in a plane perpendicular to the axis AB of the intermediate body 331. Said tolerance band makes it possible to take said added mass effect into consideration in order to correct the expression for acoustic axial length in terms of acoustic time-of-flight L=f(T) using equation E2 above.

For preference, the injector 7 may comprise a sealing means 4 inserted:
radially between the piston 330 and the cavity 20 to form a region of sealing between these, and
axially between the first 3301 and second 3302 bearing surfaces of the piston 330, to avoid axial seepage of fluid 1 which could disrupt a balance of the axial forces applied to the piston 330 and, ultimately, said fluidic connection.

Because the second bearing surface 3302 of the piston 330 is dynamically immobile because of the selective acoustic axial length L=f(T) of the penetrating member 33 as described by at least one of equations E1 or E2 above, the presence of the seal does not slow the vibrations Y₁Y₂ of the rear mass (and, in more general terms, of the actuator 3) and ultimately does nothing to disrupt the opening and/or closing of the valve of the injector 7.

Return means 11 for returning the actuator 3 may be provided in order to keep the tip 51 of the needle 5 pressed against the seat 61 of the nozzle 6 to ensure that the valve closes in the absence of fluid 1, and therefore fluidic connection, for example after the injector 7 has been assembled and before it is connected to the pressurized circuit 9 for the fluid 1 when being installed on a cylinder head 13 of the engine 8. That advantageously allows the interior 21 of the injector 7 to be protected against any dust which could, for example, short-circuit the electrodes 301 of the electroactive part 30.

The return means 11 may be represented by a preloaded coil spring positioned along the axis AB downstream of the housing 2 with respect to the direction in which the pressurized fluid 1 flows toward the nozzle 6.

1-10. (canceled)

11. An injection device for injecting pressurized fluid, having a main axis of injection, the injection device comprising:
a housing comprising at least one axial cavity filled with pressurized fluid and opening to the inside of the housing;
an actuator including a stack with a first transverse face extended axially by a penetrating member and a second transverse face axially opposite the first, the stack including at least one electroactive part comprising an electroactive material, the actuator being mounted so that it can move axially in the housing and said member comprising a piston engaged in a substantially fluid tight manner in the cavity and forming a fluidic connection between the actuator and the housing; and
energizing means designed to set the electroactive part of the actuator in vibration with a set period τ,
wherein said penetrating member includes an axial length such that the propagation time T of the acoustic waves produced by the vibrations of the electroactive part of the actuator and traveling along this length satisfies the following equation: T=[2n+1]*[τ/4], where n is a positive integer coefficient.

12. The injection device as claimed in claim 11, wherein said penetrating member comprises at least one intermediate body positioned axially between the piston and the first transverse face, and the piston protrudes radially beyond the intermediate body.

13. The injection device as claimed in claim 12, wherein said intermediate body is one of the following bodies:
(a) a first body including, transversely to said axis, at least one one-way section;
(b) a second body including, transversely to said axis, at least one solid two-way section; or
(c) a third body including, transversely to said axis, at least one hollow two-way section.

14. The injection device as claimed in claim 12, wherein said intermediate body is perforated.

15. The injection device as claimed in claim 11, further comprising a sealing unit inserted radially between the piston and the cavity.

16. The injection device as claimed in claim 11, further comprising at least one needle,
wherein the stack comprises at least an amplifier axially connected to the needle at the site of the second transverse face, the electroactive part and the needle each being positioned axially on a side of the amplifier.

17. The injection device as claimed in claim 16, wherein the stack comprises at least one rear mass, the amplifier and the rear mass each being arranged axially on a side of the electroactive part, and the rear mass includes a wall axially at the opposite end to the electroactive part, said wall coinciding with the first transverse face of the stack.

18. The injection device as claimed in claim 17, wherein the stack coincides with the actuator, and the amplifier, the electroactive part, and the rear mass are clamped together by a preload means and designed to have passing through them acoustic waves initiated by the vibrations of the electroactive part.

19. The injection device as claimed in claim 16, further comprising a nozzle comprising, along said axis, an injection orifice and a seat and being, at the opposite end, connected to the housing,
wherein the needle includes, along said axis, a free end defining a valve, in a region of contact with the seat and being, at the opposite end, connected to the stack of the actuator which sets this needle in vibration, bringing about, between an end and the seat of the nozzle, a relative movement capable of opening and closing the valve alternately.

20. An internal combustion engine system, comprising:
an internal combustion engine; and
an injection device configured to inject pressurized fluid, having a main axis of injection, into the internal combustion engine, the injection device comprising:
a housing comprising at least one axial cavity filled with pressurized fluid and opening to the inside of the housing;
an actuator including a stack with a first transverse face extended axially by a penetrating member and a second transverse face axially opposite the first, the stack including at least one electroactive part comprising an electroactive material, the actuator being mounted so that it can move axially in the housing and said member comprising a piston engaged in a substantially fluid tight manner in the cavity and forming a fluidic connection between the actuator and the housing; and
energizing means designed to set the electroactive part of the actuator in
vibration with a set period τ,
wherein said penetrating member includes an axial length such that the propagation time T of the acoustic waves produced by the vibrations of the electroactive part of the actuator and traveling along this length satisfies the following equation: T=[2n+1]*[T/4], where n is a positive integer coefficient.
